(19) United States
(12) Patent Application Publication
(10) Pub. No.: US 2026/0109630 A1
(43) Pub. Date: Apr. 23, 2026

(54) SOIL ABSORPTION MODULE FOR EFFLUENT DISPERSAL SYSTEM

(71) Applicant: Larry D. Stephens, Haslett, MI (US)

(72) Inventor: Larry D. Stephens, Haslett, MI (US)

(21) Appl. No.: 19/487,121

(22) PCT Filed: May 31, 2024
(86) PCT No.: PCT/US2024/031967

§ 371 Date: Nov. 24, 2025

Related U.S. Application Data
(60) Provisional application No. 63/505,845, filed on Jun. 2, 2023.

(51) Int. Cl. C02F 3/04; C02F 3/28

(52) U.S. Cl. CPC C02F 3/046; C02F 3/288

(57) ABSTRACT

A vertical sidewall effluent dispersal system and method for narrow trench installations. A plurality of soil absorption modules are connected in series. Each system of multiple modules receives a balanced distribution of effluent. The modules comprise a conduit segment and an elongated grid body, both contained within a geotextile envelope. An orifice in the conduit segment emits effluent onto the underlying grid body. The grid body has a first flanking side and an opposite second flanking side. The first flanking side comprises a rectilinear pattern of horizontal steps and vertical dividers. The second flanking side comprises a diamond pattern of diagonally crisscrossing spreader fins. The first and second flanking side overlap at an interior switch-back zone that directs effluent laterally back-and-forth in a downward and longitudinally spreading cascade. Each soil absorption module is isolated from the next adjacent soil absorption module by an earthen barrier of trench backfill.

### CROSS REFERENCE TO RELATED APPLICATIONS

This application claims priority to Provisional Patent Application U.S. 63/505,845 filed on Jun. 2, 2023, the entire disclosure of which is hereby incorporated by reference and relied upon.

### BACKGROUND OF THE INVENTION

Field of the Invention. The invention relates generally to dispersal systems for the treated overflow from septic tanks and advanced treatment devices, and more particularly to a soil absorption module for dispersing effluent liquid into the sidewalls of an excavated trench.

### Description of Related Art

Septic systems and other advanced treatment devices produce liquid effluent. The effluent is treated over a period of time by dispersing into the soil so that natural aerobic processes can break down, filter and purify the effluent before it reaches the water table. For this reason, septic systems and advanced treatment devices are usually equipped with a drain field configured to receive effluent into the vadose zone via capillary forces and gravity into the soil. The vadose zone is the unsaturated part of earth surface between the land surface and the top of the lower saturated soil formations. In an onsite soil absorption system it receives sewage effluent from a septic tank or other treatment system into a subsurface soil dispersal system.

It is common to configure the drain field as a system of wide trenches in which are placed lengths of drainage pipes having a series of apertures through which the effluent escapes. The pipes are embedded in the trenches and then backfilled with gravel. It has been learned through research and experience that absorption into the ground through the sidewalls of trenches is much more effective than through the bottom areas. This is especially true over time as the trench bottom becomes increasingly clogged with a layer of silt and organic matter. Undigested sewage does not tend to adhere to the trench wall, but rather naturally sluffs off so that the trench walls remain relatively free of sewage particles.

U.S. Pat. No. 4,013,559 to Johnson, issued Mar. 22, 1977, discloses a ground absorption system that uses prefabricated concrete panels grouped and connected together in relatively wide and deep trenches. Suggested trenches are 12 inches wide and greater than 4 feet deep. Each prefabricated panel section is formed with vertically spaced chambers or compartments throughout its length. In operation, effluent or wastewater leaves the septic tank and flows into the uppermost chamber of the first prefabricated panel. The wastewater seeps downwardly through a series of intermediate and lowermost chambers, while simultaneously seeping outwardly through the side walls into the surrounding soil. The cracks between adjoining cement blocks enable effluent to seep outwardly. Overflow wastewater and effluent pass through the panel to the next successive panel.

While trench systems have the advantage of absorption through the vertical side walls of the trench, examples like those mentioned above have serious drawbacks. One such drawback is that the trenches must be relatively wide and deep, requiring heavy digging equipment and suitable drain field areas. Another drawback is that the systems are arranged so that a clog in a panel or drain tile will block effluent flow downstream to subsequent parts of the system, creating a serious interruption. A still further drawback is that there is not provided any strategic method by which the effluent is distributed within the panel. Rather, as best illustrated in the aforementioned U.S. Pat. No. 4,013,559, each panel is effectively a chambered tank that receives effluent much like a catch basin.

There is therefore a need in the art for an improved effluent dispersal system adapted for placement in a narrower trench, together with an improved soil absorption panel that overcomes the current drawbacks.

### BRIEF SUMMARY OF THE INVENTION

According to a first aspect of the invention a soil absorption module is provided for an effluent dispersal system. The module comprises a conduit segment extending between upstream and downstream ends. An orifice is disposed in the conduit segment between the upstream and downstream ends. An elongated grid body is located substantially in alignment below the conduit segment. The grid body has a leading end proximate the upstream end of the conduit segment and a trailing end proximate the downstream end of the conduit segment. The grid body has a first flanking side and an opposite second flanking side. The first flanking side comprises a plurality of horizontal steps. Each horizontal step has an interior edge and an exterior edge. The first flanking side also comprises a plurality of vertical dividers. The second flanking side comprises a plurality of spreader fins adapted to disperse effluent longitudinally within the grid body. The interior edges of the horizontal steps overlap the spreader fins within an interior switch-back zone. The switch-back zone is configured to direct effluent laterally back-and-forth in a downward and longitudinally spreading propagation. A geotextile envelope surrounds the conduit segment and the grid body.

According to another aspect of the invention. A vertical sidewall effluent dispersal system is adapted for placement in a trench. The system comprises a plurality of soil absorption modules connected in series. Each soil absorption module comprises a conduit segment, an elongated grid body and a geotextile envelope. The conduit segment extends between upstream and downstream ends. An orifice in the conduit segment is disposed between the upstream and downstream ends. The elongated grid body is disposed substantially in alignment below the conduit segment. The grid body has a first flanking side and an opposite second flanking side. The first flanking side comprises a plurality of horizontal steps and a plurality of vertical dividers arranged in a rectilinear pattern. The second flanking side comprises a plurality of spreader fins diagonally crisscrossing one another in a diamond pattern. The horizontal steps and vertical dividers overlap the spreader fins at an interior switch-back zone configured to direct effluent laterally back-and-forth in a downward and longitudinally spreading propagation. The geotextile envelope surrounds the conduit segment and the grid body. Each soil absorption module is isolated from the next adjacent soil absorption module by an earthen barrier.

According to a further aspect of the invention, a method is provided for forming an effluent treatment system. The method includes excavating a trench in the earth, placing in the trench at least two soil absorption modules, attaching the downstream end of one soil absorption module to the upstream end of the other soil absorption module at a spaced apart distance, and finally backfilling the trench with a granular material so that each soil absorption module is surrounded with the granular material. The backfilling step includes forming an earthen barrier between the ends of adjacent soil absorption modules to isolate each soil absorption module.

The present invention overcomes the drawbacks and shortcomings associated with known effluent dispersal systems adapted for placement in a trench.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is an exploded view of a soil absorption module according to an embodiment having a conduit segment, an elongated grid body and a geotextile envelope;

FIG. 2A is a front perspective view showing the first flanking side of the grid body;

FIG. 2B is a rear perspective view showing the second flanking side of the grid body;

FIG. 3 is a front elevation view of the grid body;

FIG. 4 is a rear elevation view of the grid body;

FIG. 5 is a left end view of the grid body, the right end view being a mirror image thereof;

FIG. 6 is a top view of the grid body;

FIG. 7 is bottom view of the grid body;

FIG. 8 is a fragmentary view of a soil dispersion module illustrating with directional arrows movement of effluent within the grid body;

FIG. 9 is a cross-sectional view taken generally along lines 9-9 of FIG. 8 and showing the soil dispersion module within a geotextile envelope installed for use in a backfilled trench;

FIG. 10 is an enlarged view of FIG. 9 depicting with directional arrows movement of effluent within the grid body and into the surrounding soil;

FIG. 11 is an enlarged, fragmentary cross-sectional view as in FIG. 9 with the switch-back zone indicated by broken lines;

FIG. 12 is an enlarged, fragmentary perspective view indicating the switch-back zone with broken lines and surface shading;

FIG. 13A-C are simplified views showing in sequence the steps of forming a trench, installing soil dispersion modules in the trench, and backfilling the trench;

FIG. 14 is a simplified schematic view of an effluent treatment system comprised of three modules into which the flow of effluent has been balanced;

FIG. 15 is a simplified plan view showing an effluent treatment system comprised of a plurality of branch lines configured in parallel;

FIG. 16 is another simplified view showing an effluent treatment system comprised of a plurality of branch lines configured in opposing parallel rows;

FIG. 17 is yet another simplified view showing an effluent treatment system comprised of a plurality of branch lines configured in opposing parallel rows set in a terraced scheme; and

FIG. 18 shows repair of an effluent treatment system in which defective modules are bypassed.

### DETAILED DESCRIPTION OF THE INVENTION

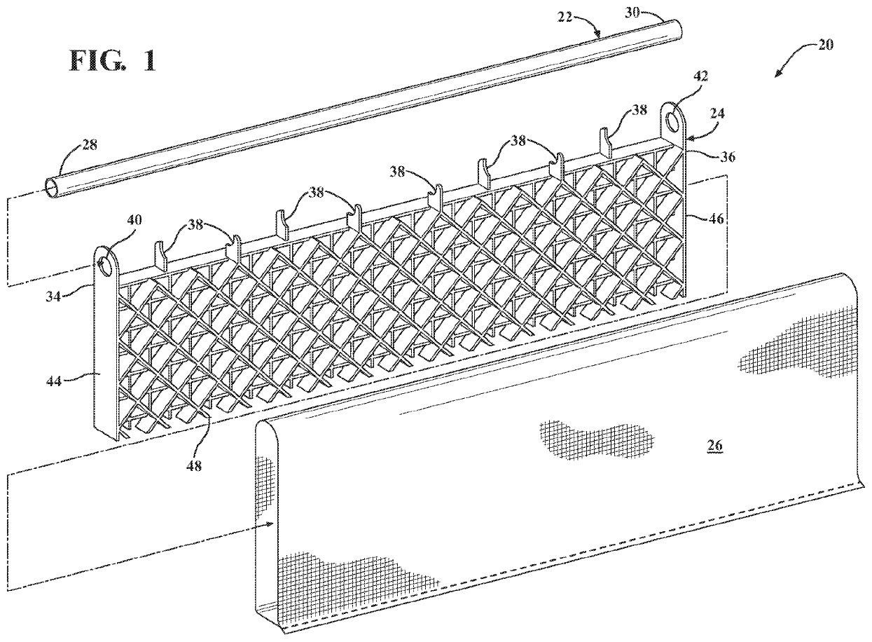

Referring to the figures, wherein like numerals indicate like or corresponding parts throughout the several views, a soil absorption module according to one exemplary embodiment of the invention is generally shown at 20 in FIG. 1. The term “soil” is used in a broad, generic sense to mean any form of granular material into which an effluent may be dispersed. In many cases, soil will consist of the common mixture of sand, silt, clay and rock particles. However, those of skill in the art will appreciate that soils could also include synthetic materials, stones, sand, silt, and so on, either native to the site or imported.

The soil absorption module 20 is part of a vertical sidewall dispersal system for effluent from septic tanks and advanced treatment systems (FIGS. 15-18). In some applications, the system can be used to distribute excess water not necessary from a sewage source. The soil absorption module 20 is intended to be connected, in series, to other like soil absorption modules 20 and operate through presentation of effluent for dispersal predominantly through its sides rather than through its bottom. The series of connected modules 20 together form part of a soil dispersal system for effluent from septic tanks or other types of advanced treatment systems. The modules 20 are deployed in narrow, excavated trenches. Within the dispersal system, each soil absorption module 20 functions as a substantially independent drainage pod from which effluent flows laterally and horizontally to be dispersed predominantly into the sidewalls of the trench, although it is expected that a relatively minor portion of effluent will be dispersed downwardly into the bottom of the trench. Sloughing biomass, suspended solids and silt in the effluent will advantageously tend to wash to the bottom of each module 20 rather than accumulate along the sidewalls, thus enabling extended service life.

The soil absorption module 20 may be fabricated from a non-metallic material suitable for wet, underground applications. For example, the soil absorption module 20 could be made from polyethylene, PVC or other composite material. In fact, a wide range of suitable materials could be suited for use and will be known to those of skill in the art.

Turning now to FIG. 1, a soil absorption module 20 according to an exemplary embodiment of the invention is shown in exploded view. Generally stated, each module 20 is comprised of a segment of conduit 22, a grid body 24 and a geotextile sleeve or envelope 26. The geotextile envelope 26 surrounds the conduit segment 22 and the grid body 24. Generally stated, the geotextile envelope 26 prevents or minimizes soil infiltration into the grid body 24 while enabling the effluent to escape. The geotextile envelope 26 can be fabricated from any number of commercially available permeable fabrics.

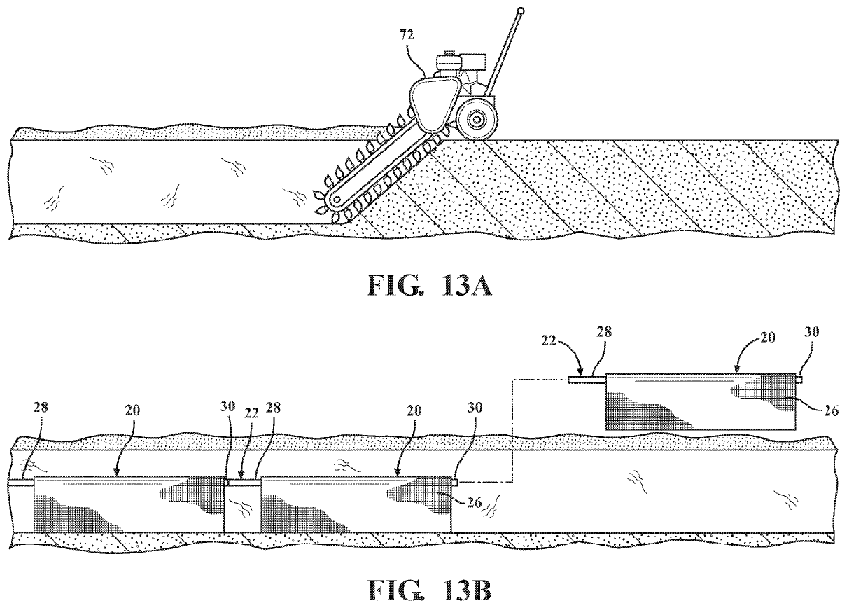

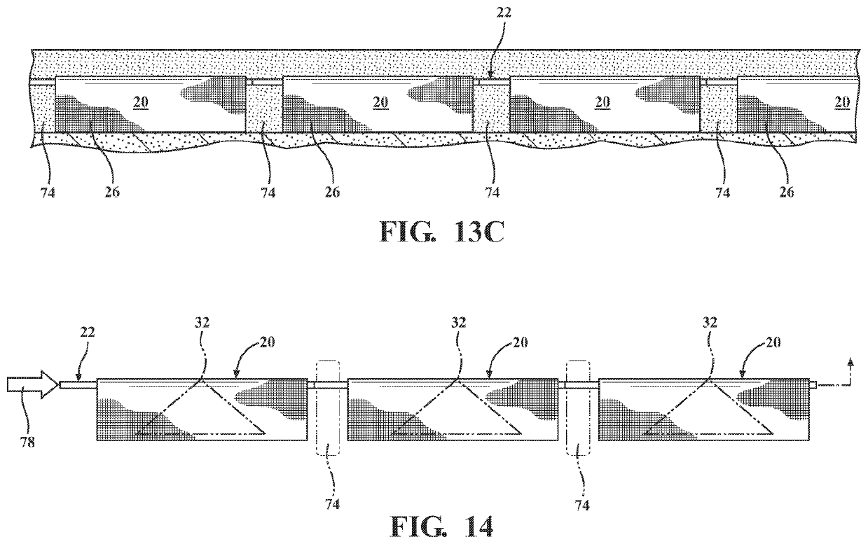

The conduit segment 22 may be of any type and size suitable for dispersal systems. Schedule 40 PCV pipe is considered an acceptable option. In the illustrated examples, 1-inch PVC 1120 SCH 40 pipe is shown. The conduit segment 22 extends generally horizontally and longitudinally between an upstream end 28 and a downstream end 30 (FIG. 13B). Effluent is intended to flow though the conduit segment 22 in the downstream direction. Although the conduit segment 22 is oriented for use in the generally horizontal position, it will be understood by those skilled in the art that a pressurized pipe and/or some slope may be preferred to facilitate movement of the effluent toward the downstream end 30. In some cases, the module 20 is not flow-direction specific, meaning that the upstream 28 and downstream 30 ends are only determined in the field based on the discretion of the system designer/installer. That is to say, the module 20 will operate with substantially equal effectiveness regardless of which end is upstream/downstream. In other embodiments, the upstream end 28 could be flared to enable a mated fit with the downstream end 30 of a preceding module 20, thereby avoiding the need for a coupling sleeve when joining modules 20 end-to-end in series.

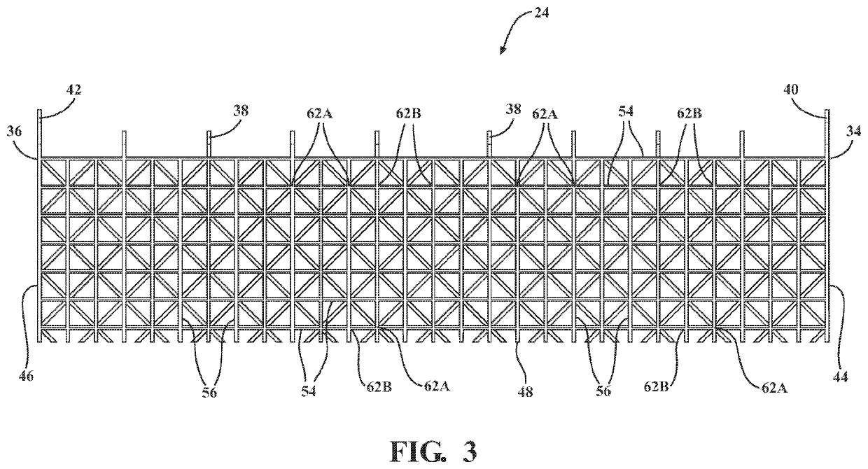

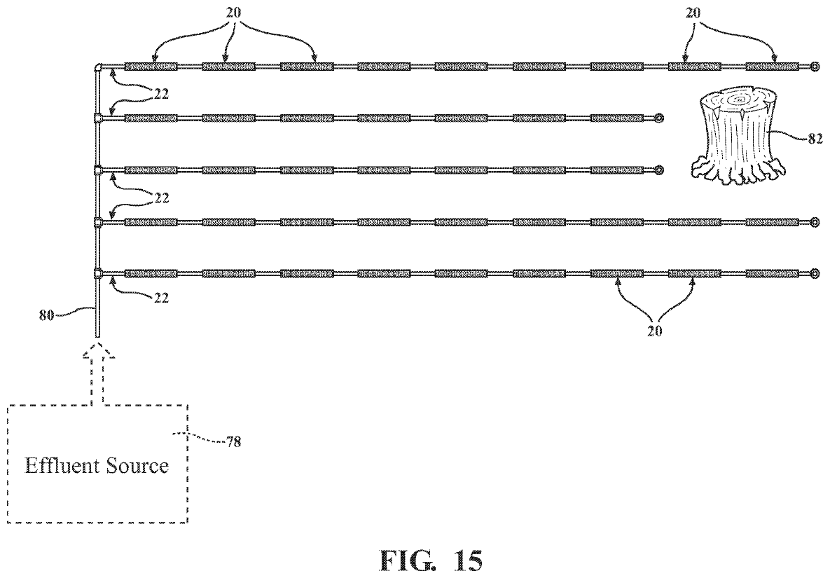

In the illustrated examples, the conduit segment 22 is defined by a generally tubular sidewall. An orifice 32 (see FIGS. 3, 4, 8 & 9) is disposed in the sidewall of the conduit segment 22 between the upstream 28 and downstream 30 ends. Preferably, but not necessarily, the orifice 32 is located generally mid-length and oriented in a vertically downward direction. In this manner, the orifice 32 will emit effluent onto the approximate mid-point of the underlying grid body 24. The size of the orifice 32 can be varied to manage the rate of effluent discharge. In cases where more effluent discharge is required, two or even three orifices 32 could be formed in the conduit segment 22. As will be mentioned later in connection with FIG. 14, a dispersal system composed of many modules 20 joined in series is preferably balanced so that the rate of effluent discharge is generally equal from each module 20 in the system. This balancing can be accomplished by the use of a feed pump, by adjusting the size of the feed pipes, and by limiting the number of modules in each lateral.

The grid body 24 is an elongated, somewhat box-like member disposed substantially below the conduit segment 22. The grid body 24 has a leading end 34 proximate the upstream end 28 of the conduit segment 22 and a trailing end 36 proximate the downstream end 30 of the conduit segment 22. As mentioned previously, in some cases the module 20 will operate with substantially equal effectiveness regardless of which end is situated as upstream. In such cases, the leading 34 and trailing 36 ends of the grid body 24 are only determined in the field at the discretion of the installer. In any event, the leading end 34 will be closest to the upstream end 28 of the conduit segment 22 and the trailing end 36 will be closest to the downstream end 30 of the conduit segment 22.

Along the top of the grid body 24 is provided at least one cradle 38 in registry with the lower-facing sidewall of the conduit segment 22. In the illustrated examples, a plurality of cradles 38 are provided along the top of the grid body 24, arranged in opposing quarter-circles, to distribute support for the conduit segment 22. However, the cradles 38 can take any convenient form. In addition to the cradles 38, the grid body 24 may also include at least one connector for securing the grid body 24 to the conduit segment 22. In the examples shown, two connectors are shown: a leading connector 40 adjacent the leading end 34 and a trailing connector 42 adjacent the trailing end 36. The connectors 38, 40 can take any number of different configurations to accomplish the purpose of securing the conduit segment 22 resting in the cradle(s) 38 and to the grid body 24. At least one of the leading 38 and trailing 40 connectors may comprise an eyelet. In the examples shown, both leading 38 and trailing 40 connectors comprise an eyelet. That is, the connectors 38,40 are depicted as holes in tabs through which the conduit segment 22 is. mounted. However, those of skill in the art will be able to envision alternative connector schemes.

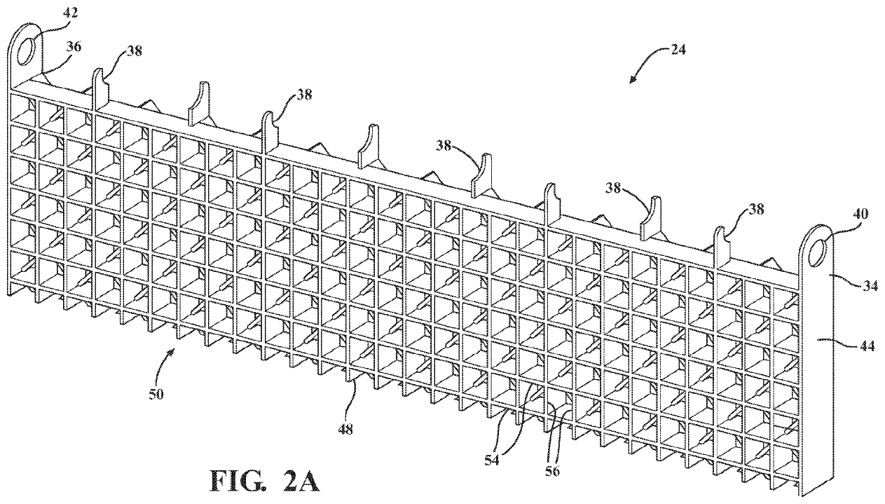

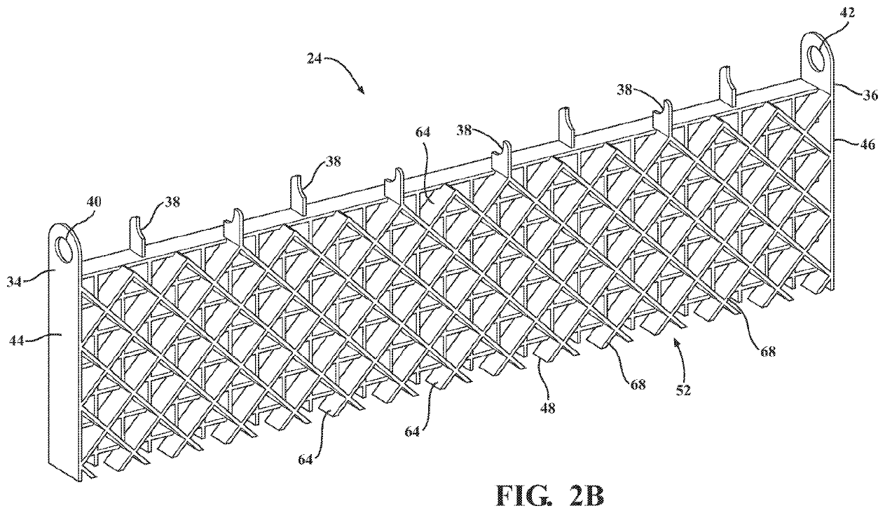

As perhaps best shown in FIGS. 2A and 2B, the grid body 24 has a leading end wall 44 adjacent the leading end 34 and a complimentary trailing end wall 46 adjacent the trailing end 36. At least one of the end walls 44, 46 may be configured as non-porous. It the examples shown, both end walls 44, 46 appear as non-porous. However, in some contemplated embodiments one or both end walls 44, 46 may be designed to allow effluent to pass through. Non-porous end walls 44, 46 could be considered beneficial in cases where it is desired to isolate each soil absorption module 20 from the next adjacent module 20 in series-an advantage that will be described in greater detail below.

The bottom of the grid body 24 comprises a base 48. The base 48 extends between the leading 44 and trailing 46 end walls, generally directly underneath the conduit segment 22. In the examples shown, the base 48 is porous, enabling effluent to pass downwardly through the module 20.

The soil absorption module 20 is primarily configured as a sidewall dispersal system, meaning that the sides of the grid body 24 are predominantly responsible for dispersing effluent laterally into the surrounding soil with only a minor portion of effluent being directed downwardly for dispersal into the underlying soil. As such, the grid body 24 is seen having a first flanking side, generally indicated at 50, and an opposite second flanking side, generally indicated at 52. The first 50 and second 52 flanking sides are configured to disperse effluent longitudinally within the grid body 24 while presenting effluent to the respective outer sides to accomplish the aforementioned vertical sidewall dispersion technique. However, the design is such that the second flanking side 52 disperses effluent longitudinally within the grid body according to a different schema than the longitudinal dispersion effects of the first flanking side 50. As a consequence, the first 50 and second 52 flanking sides operate in concert to distribute effluent longitudinally within the grid body 24 while also concurrently urging the effluent toward the respective outsides so as to accomplish a vertical sidewall dispersal approach. Further details about effluent distribution within the grid body 24 will be described subsequently.

In most applications, it does not matter whether the first flanking side 50 is on the left-hand side of the module 20 or on the right-hand side. As mentioned before, the module 20 can be designed to operate with substantially equal effectiveness regardless of which end 34, 36 is upstream. The first 50 and second 52 flanking sides each fully fill the interior boundary of the grid body 24 below the cradles 38. That is, the flanking sides 50, 52 are bounded by the leading 44 and trailing 46 end walls and by the base 48, and underneath the cradles 38.

The first flanking side 50 is fully visible in the perspective view of FIG. 2A. Here, the first flanking side 50 can be seen having a checkerboard appearance somewhat reminiscent of an egg crate ceiling light panel or perhaps an ice cube tray. The cube-like matrix is composed of a plurality of horizontal steps 54 with intersecting vertical dividers 56. The horizontal steps 54 run longitudinally, i.e., generally parallel to the conduit segment 22, between the leading 44 and trailing 46 end walls. The vertical dividers 56 run generally perpendicular to the conduit segment 22 between the base 48 and the cradles 38. A node 62A/B is formed where each vertical divider 56 intersects a horizontal step 54. Preferably, but by no means necessarily, the horizontal steps 54 are equally spaced apart and likewise the vertical dividers 56 are also equally spaced apart creating individual cells of regular square or rectangular shape. In some contemplated embodiments, the spacing between the horizontal steps 54 and/or the vertical dividers 56 can be varied to achieve progressive increasing or decreasing separations.

FIGS. 9 & 10 show the horizontal steps 54 in cross-section. In these views, in can be observed that each horizontal step 54 has an interior edge 58 and an exterior edge 60. The interior edges 58 are sheltered within the grid body 24, whereas the exterior edges 60 lay along the first flanking side 50. More specifically, the exterior edges 60 establish the vertical sidewall of the first flanking side 50. Preferably, the interior edges 58 are all vertically aligned with one another, and similarly the exterior edges 60 are also all vertically aligned with one another. It can be noticed that the exterior edge 60 of each horizontal step 54 is pitched downwardly relative to its interior edge 58 producing a slight downward slope that will encourage liquid effluent to travel laterally outwardly. Or perhaps more simply put, each horizontal step 54 is pitched to produce a slope falling away from the second flanking side.

The second flanking side 52 is fully visible in the perspective view of FIG. 2B. From this view, it can be seen that the second flanking side 52 comprises a plurality of spreader fins 64. As previously mentioned, the spreader fins 64 disperse effluent longitudinally within the grid body 24 according to a different schema than the longitudinal dispersion effects of the horizontal steps 54 and vertical dividers 56. Whereas the horizontal steps 54 and vertical dividers 56 where arranged as a rectilinear grid, the spreader fins 64 diagonally crisscross one another to form diamond-shaped spaces between.

Turning once again to the cross-sectional views in FIGS. 9 & 10, in can be observed that the spreader fins 64 have interior edges 66 and exterior edges 68. The interior edges 66 are sheltered within the grid body 24, whereas the exterior edges 68 establish the vertical sidewall of the second flanking side 52. Preferably, the interior edges 66 are all vertically aligned with one another, and similarly the exterior edges 68 are also all vertically aligned with one another.

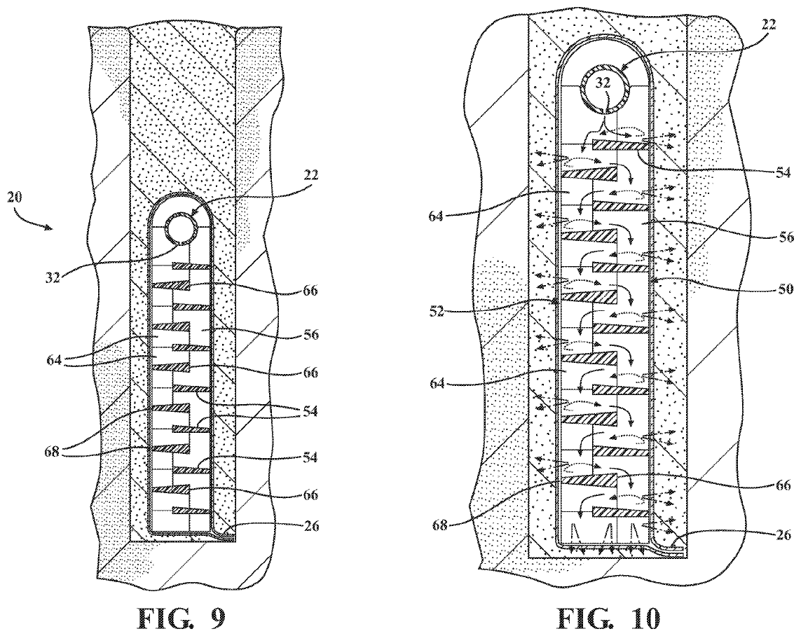

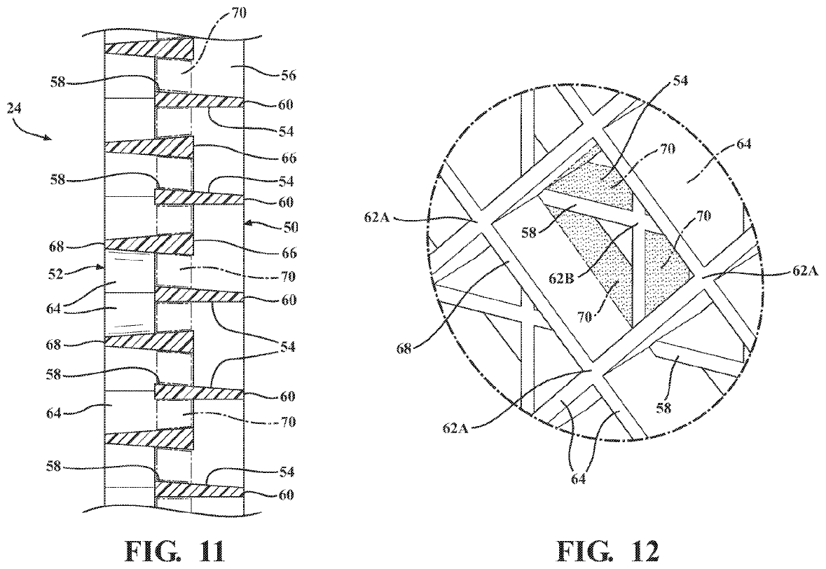

Considering still FIGS. 9 and 10, but also with reference to FIGS. 11 and 12, careful inspection will reveal that the interior edges 58 of the horizontal steps 54 and the vertical dividers 56 overlap the spreader fins 64 at an included switch-back zone 70. And likewise, it can be said that the interior edges 66 of the spreader fins 64 overlap the horizontal steps 54 and vertical dividers 56 in the switch-back zone 70. In FIGS. 11 and 12, the switch-back zone 70 is shown as an interior region bounded with broken lines, generally straddling the longitudinal centerline of the grid body 24. The switch-back zone 70 is a feature of the present invention that enables effluent to readily flow back-and-forth between the grid layers in a downward and longitudinally spreading propagation. That is to say, as effluent cascades down the grid body 24, the flow of effluent travels back-and-forth between the vertical sidewalls, as shown graphically in FIG. 10. The switch-back zone 70 carries the effluent from one side to the other side, i.e., between the first 50 and second 52 flanking sides, so that each side 50, 52 is enabled to disperse effluent longitudinally and laterally into the surrounding soil according to its vertical sidewall dispersion schema. The switch-back zone 70 can also be understood as effectively preventing effluent from falling rapidly to the base 48 of the grid body 24, without interacting with the vertical sidewalls, which has been a particular disadvantage in certain prior art designs.

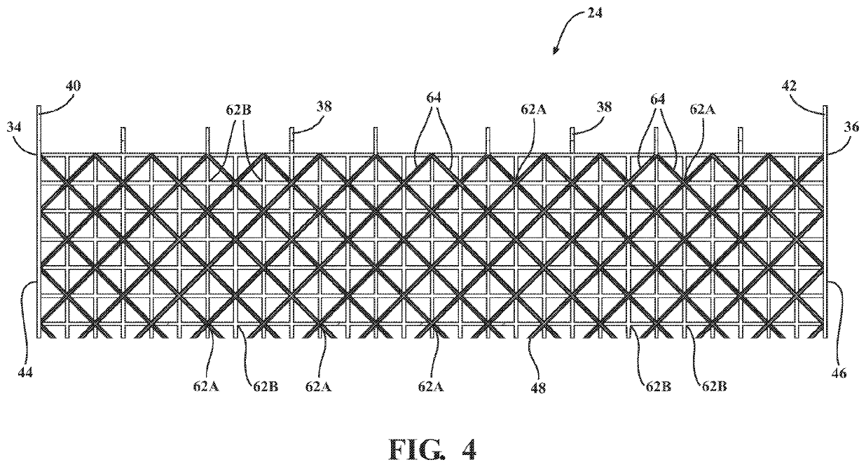

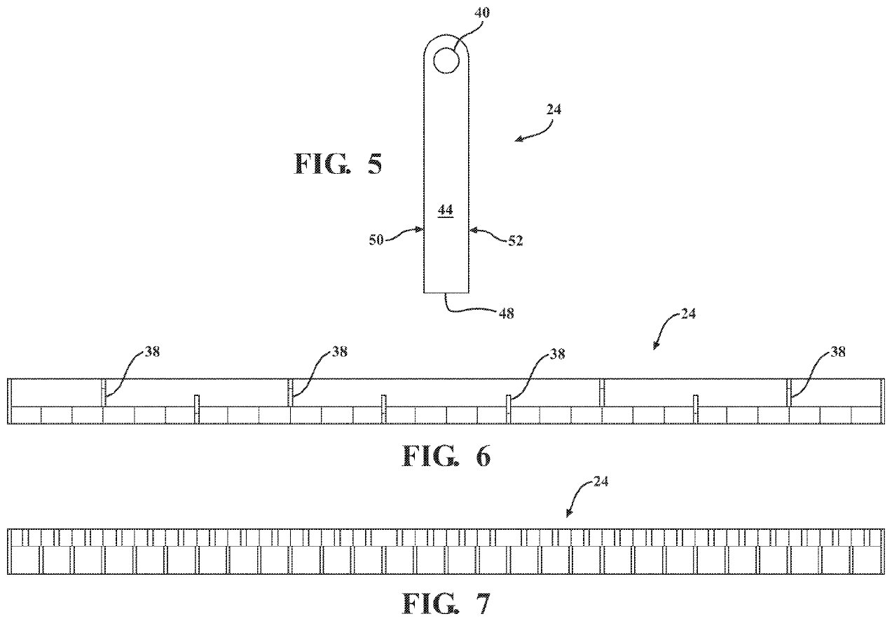

To help assist with the distinctive dispersion schema of the second flanking side 52, the spreader fins 64 may be designed to crisscross at respective nodes 62A of the first flanking side 50 within the switch-back zone 70. The nodes 62A intersect with the spreader fins 64. In the illustrated examples, the spreader fins 64 crisscross exclusively at intersecting nodes 62A, thus indicating that all of the spreader fins 64 directly contact the vertical dividers 56 as well as the horizontal steps 54. This aspect may be best appreciated by reference to the elevation views of FIGS. 3 and 4. Moreover, the diamond-shaped spaces formed by the spreader fins 64 are preferably larger than the square cells of the first flanking side 50. In the example of FIGS. 3 and 4, the horizontal point-to-point measure of each diamond-shaped space of the spreader fins 64 is equal to two square cells of the first flanking side 50. And likewise, the vertical point-to-point measure of each diamond-shaped space of the spreader fins 64 is equal to two square cells of the first flanking side 50. In this way, it can be observed that while all of the spreader fins 64 crisscross exclusively at intersecting nodes 62A, there are also numerous open nodes 64B that do not contact the spreader fins 64. In fact, in both vertical and horizontal directions, every other node is an open node 62B that does not intersect with the spreader fins 64 in the illustrated examples.

The dispersion of effluent within a grid body 24 is multidimensional and thus somewhat complex to describe. It may help to describe the effluent dispersion in terms of its separate longitudinal/vertical and lateral/vertical components.

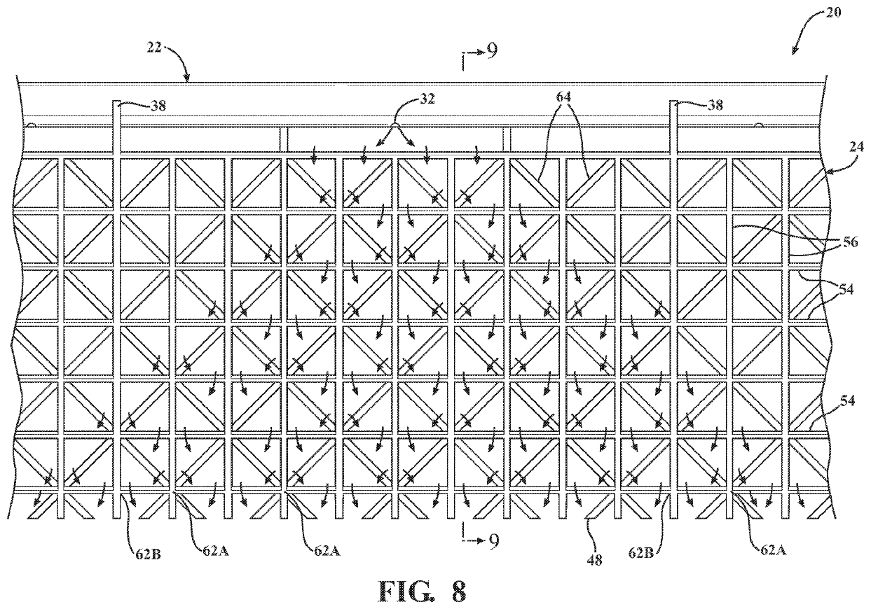

Turning first to FIG. 8, the longitudinal/vertical dispersion of effluent within a grid body 24 will be described. Small directional arrows appear in FIG. 8 to depict the cascading flow of effluent from the conduit segment 22 to the base 48 of the grid body 24. Immediately upon exiting the orifice 32, effluent will encounter on the one side 50 the uppermost horizontal step 54, and on the other side 52 several spreader fins 64. Because the first 50 and second 52 flanking sides operate in concert to distribute effluent longitudinally within the grid body 24, it is necessary to mention how the effluent interacts with each side 50, 52 as it descends toward the base 48. Some effluent that lands on the uppermost horizontal step 54 is directed toward the exterior edge 60, and the remaining portion moves through the switch-back zone 70 and toward the interior edge 58 where is merges with effluent flowing down the spreader fins 64. Upon encountering intersecting nodes 62A, some effluent is directed toward the exterior edge 66, and the remaining portion enters the switch-back zone 70 whether it is split by vertical dividers 56 more or less equally before being deposited on the corresponding horizontal step 54. The cycle then repeats itself layer by layer in a cascading manner, with the effluent being progressively spread in the leading and trailing directions, i.e., longitudinally, while also currently being presented against the geotextile envelope 26 on opposing sides 50, 52.

Turning now to FIG. 10, the lateral/vertical dispersion of effluent within the grid body 24 will be described. Again, small directional arrows depict the cascading flow of effluent from the conduit segment 22 to the base 48 of the grid body 24. Immediately upon exiting the orifice 32, effluent encounters the uppermost horizontal step 54 on one side 50, and several spreader fins 64 on the other side 52. Some of the effluent landing on the uppermost horizontal step 54 is presented to the geotextile 26 for sidewall dispersion into the soil. The remaining portion of effluent traverses the switch-back zone 70 and falls over the interior edge 58 to be merged with effluent flowing down the spreader fins 64. Some of this effluent is presented to the geotextile 26 for sidewall dispersion into the soil, while the remainder flows through the switch-back zone 70 where it is split by vertical dividers 56 at an intersecting node 62A. Passing through the intersecting node 62, the effluent is split before being deposited on the next lower horizontal step 54. The cycle of course repeats itself layer by layer in a cascading manner, with the effluent being continuously presented against the geotextile envelope 26 on opposing sides 50, 52 as it migrates toward the base 48. Residual effluent at the base 48 can be dispersed into the soil underlying the grid body 24.

Especially from FIG. 10 it can be appreciated that the switch-back zone 70 is a region through which the effluent flows back-and-forth as it is continuously spread longitudinally and given maximum opportunity to be absorbed laterally into the surrounding soil through the vertical sidewalls of the module 20. Particular features and advantages of a sidewall dispersal system effectuated through a soil absorption module 20 according to this invention include efficient dispersal of effluent into the vadose zone via capillary forces in the soil. Those of skill in the art will recognize that the vadose zone is the unsaturated part of earth between the land surface and the top of the saturated soil formations below. The vertical sidewall dispersal method is expected to maintain aerobic conditions on the sidewall for the life of the system. The module 20 forces the effluent to move laterally and horizontally while concurrently contacting the sidewalls and trickling down to the base 48 by gravity. These and many other advantages are enabled by the module 20.

FIGS. 13A-C graphically depict, in a highly simplified manner, a method for installing modules 20 in series as part of an effluent treatment system. FIG. 13A shows a selected dispersal site being prepared by digging an elongated trench in the earth. In this example, a simple trencher machine 72 is depicted although other types of tools and methods can be used to form a long, narrow trench in the vadose zone. Advantageously, the module 20 can be configured with a relatively narrow body width so that the trench need only be about 4-6 inches wide. Wider trenches may be acceptable for use but will require additional effort to dig and later re-fill. The depth of the trench is preferably such that the module 20 will reside shallow in the soil profile where native conditions are normally more permeable.

FIG. 13B shows a completed trench. It may be desirable to place the modules 20 directly on the bottom of the trench. Modules 20 set in the trench are connected by their respective conduit segments 22 end-to-end in series. It will be noticed that the modules 20 are intentionally spaced apart from one another in the trench. FIG. 13C depicts the completed installation with soil or other aggregate backfilling the trench. The series of modules 20 are thus buried below grade level in the vadose zone, with back-fill soil or other aggregate filling the separation between adjacent modules 20 and forming earthen barriers 74. The earthen barriers 74 effectively isolate each module 20 in the system. This advantageously allows each module 20 to function somewhat independently of the other modules 20.

In FIG. 14, a highly simplified schematic representation of a system composed of just three modules 20 connected in series. Earthen barriers 74 are indicated between each module 20. Effluent enters the upstream end 28 of the conduit segment 22 in the leading module 20. Thus, in the most simplified terms, the method of installing modules 20 to form a dispersal system comprises the steps of digging an elongated trench in the earth, placing in the trench at least two trench modules 20, attaching the downstream end of one module to the upstream end of the other module 20 at a spaced apart distance, and then backfilling the trench with soil or other granular material so that each module 20 is surrounded with soil. One key aspect of this backfilling step includes isolating the modules 20 from one another by filling the spaced apart distance to form an earther barrier 74 in-between.

One goal, or possible goal, of the invention is to balance, at least approximately, the distribution of effluent among the plurality of modules 20. I.e., about the same quantity of effluent is distributed to each module 20 in the plurality of modules 20 comprising a system or branch of a system. In the simplified example of FIG. 14 comprising three modules 20, the effluent is distributed more or less equally among the three modules 20. This can be accomplished with a plurality of modules 20 by limiting the number of modules 20 in each lateral and varying the size and location of effluent feed pipes. The orifice 32 size in each module 20 can also be changed to accommodate different size systems. By balancing the flow of effluent into the several modules 20 in a system, it can be expected that the service longevity of each module 20 will be generally the same throughout the entire dispersal system.

FIGS. 15-17 illustrate systems of varying complexity and as may be indicated by particular conditions of the dispersal site. Considering first FIG. 15, a dispersal system is shown having an effluent source 78, which could for example be a septic tank or some other type of advanced treatment device. A main conduit 80 runs from the effluent source 78 to a dispersal field where five branch lines support parallel runs of modules 20. Each branch line is formed according to the procedures described above in connection with FIGS. 13A-14. In an idealized dispersal system design, approximately equal amounts of effluent will be delivered to each of the modules in each of the connected rows of modules. Because of the vertical sidewall dispersal scheme enabled by the modules 20, it is contemplated that in some applications the trenches (i.e., branch lines) can be spaced as closely as 24-inches apart, which could be particularly advantageous when limited space is available.

FIG. 15 also shows an obstacle 82 in the dispersal field, in the exemplary form of a tree trunk. One very advantageous aspect of this invention is the ease with which adaptations can be made to accommodate obstacles 82 of various kinds. In the simplistic example of FIG. 15, two branch lines are shortened due to the obstacle. Those of skill in the art will readily appreciate the many ways in which a modular, adaptable system of this type can be utilized within a wide range of applications.

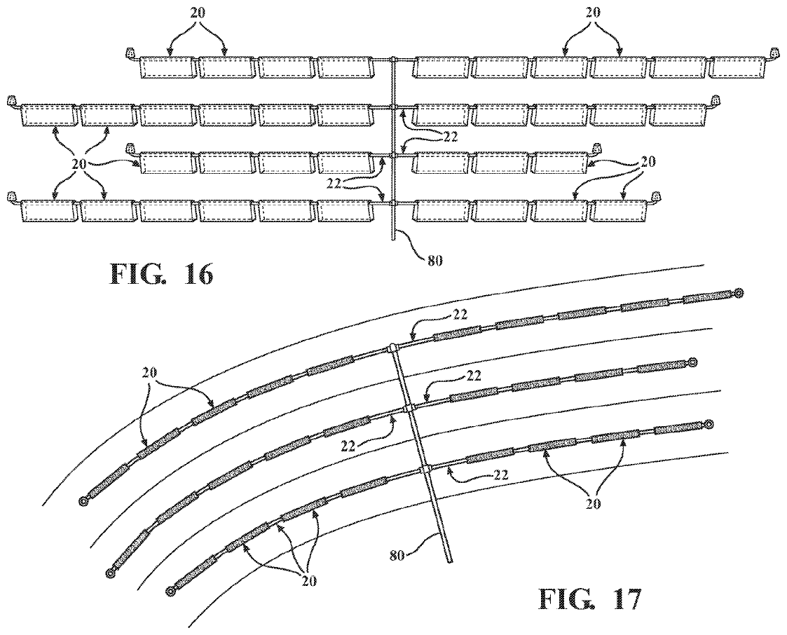

FIG. 16 shows another configuration of the system portrayed in FIG. 15, by including branch lines on opposite sides of the main conduit 80 running from an effluent source (not shown). FIG. 17 expands the concept still further by suggesting a terraced approach in which branch lines can be set at different elevations to accommodate the given topography.

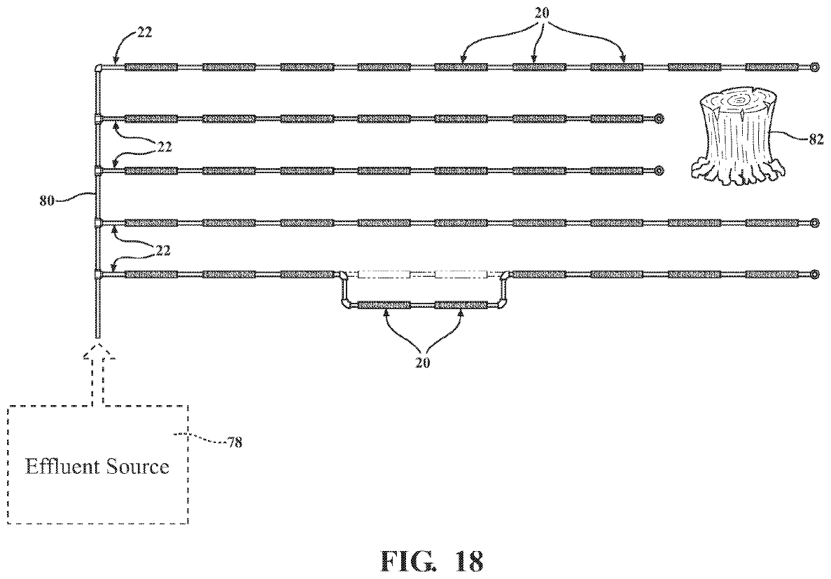

Yet another unique advantage of the present invention is illustrated by way of FIG. 18. In this example, it is imagined that a system like that of FIG. 15 has been in service for some time. Through some misfortune, two modules 20 in the first branch line become defective. For example, perhaps the two modules 20 are made defective by an external event such as an errant excavation, ingrown tree roots or heavy ground strike. Or perhaps the defect arises from an internal event such as clogging. Regardless of the reason, it is desired to remediate the defect. In this example, a new repair trench is dug alongside the two defective modules 20. Two new modules 20 are placed in the trench and spliced into the branch line, thus bypassing the defective modules 20 which could if desired be left dormant in the earth. Those of skill in the art will very readily imagine many more ways in which a modular, adaptable system of this type can be utilized.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A soil absorption module for an effluent dispersal system, comprising:
a conduit segment extending between upstream and downstream ends, an orifice in said conduit segment disposed between said upstream and downstream ends,
an elongated grid body disposed substantially in alignment below said conduit segment, said grid body having a leading end proximate said upstream end of said conduit segment and a trailing end proximate said downstream end of said conduit segment, said grid body having a first flanking side and an opposite second flanking side, said first flanking side comprising a plurality of horizontal steps, each said horizontal step having an interior edge and an exterior edge, said first flanking side comprising a plurality of vertical dividers, said second flanking side comprising a plurality of spreader fins adapted to disperse effluent longitudinally within said grid body, said interior edges of said horizontal steps overlapping said spreader fins at an interior switch-back zone configured to direct effluent laterally back-and-forth in a downward and longitudinally spreading propagation, and
a geotextile envelope surrounding said conduit segment and said grid body.

2. The soil absorption module of claim 1, wherein said spreader fins diagonally crisscross one another to form diamond-shaped spaces between.

3. The soil absorption module of claim 2, wherein said spreader fins cross one another at respective intersect nodes within said switch-back zone.

4. The soil absorption module of claim 3, wherein said vertical dividers cross said horizontal steps at alternating intersect nodes and open nodes.

5. The soil absorption module of claim 2, wherein said grid body has a leading end wall adjacent said leading end thereof and a trailing end wall adjacent said trailing end thereof, said horizontal steps extending between said leading and trailing end walls, said horizontal steps being generally equally spaced apart from one another.

6. The soil absorption module of claim 5, wherein said vertical dividers are generally equally spaced apart between said leading and trailing end walls.

7. The soil absorption module of claim 1, wherein said exterior edge of each said horizontal step is pitched relative to said interior edge producing a downward slope.

8. The soil absorption module of claim 1, wherein said orifice is oriented in a vertically downward direction.

9. The soil absorption module of claim 1, wherein said grid body includes at least one cradle in registry with said conduit segment.

10. The soil absorption module of claim 1, wherein said grid body has a leading end wall adjacent said leading end thereof and a trailing end wall adjacent said trailing end thereof, said grid body having a base extending between said leading and trailing end walls, each of said first and second flanking sides bounded within said leading and trailing end walls and said base,
said grid body including a leading connector adjacent said leading end thereof.

11. The soil absorption module of claim 10, wherein said leading connector securing said leading end of said grid body to said conduit segment and a trailing connector adjacent said trailing end of said grid body.

12. The soil absorption module of claim 11, wherein at least one of said leading and trailing connectors comprises an eyelet.

13. The soil absorption module of claim 10, wherein at least one of said leading end wall and said trailing end wall is non-porous.

14. A vertical sidewall effluent dispersal system adapted for placement in a trench, said system comprising:
a plurality of soil absorption modules connected in series, each said soil absorption module comprising:
A) a conduit segment extending between upstream and downstream ends, an orifice in said conduit segment disposed between said upstream and downstream ends,
B) an elongated grid body disposed substantially in alignment below said conduit segment, said grid body having a first flanking side and an opposite second flanking side, said first flanking side comprising a plurality of horizontal steps and a plurality of vertical dividers arranged in a rectilinear pattern, said second flanking side comprising a plurality of spreader fins diagonally crisscrossing one another in a diamond pattern, said horizontal steps and said vertical dividers overlapping said spreader fins at an interior switch-back zone configured to direct effluent laterally back-and-forth in a downward and longitudinally spreading propagation, and
C) a geotextile envelope surrounding said conduit segment and said grid body,
and wherein each said soil absorption module is isolated from the next adjacent soil absorption module by an earthen barrier.

15. The soil absorption module of claim 14, wherein each said horizontal step is pitched away from said second flanking side.

16. The soil absorption module of claim 14, wherein said grid body includes at least one cradle in registry with said conduit segment.

17. The soil absorption module of claim 14, wherein said grid body has a leading end wall adjacent said leading end thereof and a trailing end wall adjacent said trailing end thereof, said grid body having a base extending between said leading and trailing end walls, each of said first and second flanking sides bounded within said leading and trailing end walls and said base,
said grid body including a leading connector adjacent said leading end thereof.

18. A method for forming an effluent dispersal system, said method comprising the steps of:
excavating a trench in the earth,
placing in the trench at least two soil absorption modules according to claim 1,
attaching the downstream end of one soil absorption module to the upstream end of the other soil absorption module at a spaced apart distance, and
backfilling the trench with a granular material so that each soil absorption module is surrounded with the granular material, said backfilling step including forming an earthen barrier between adjacent soil absorption modules to isolate each soil absorption module.

19. The method of claim 18, wherein said excavating step includes forming a plurality of parallel trenches to accommodate branch lines.

20. The method of claim 18, further including balancing the distribution of effluent into each soil absorption module so that approximately the same quantity of effluent is distributed to each module in the plurality of modules.
